(19) United States
(12) Patent Application Publication
(10) Pub. No.: US 2025/0177956 A1
(43) Pub. Date: Jun. 5, 2025

(54) CATALYST FOR HYDROGENOLYSIS REACTION OF WASTE PLASTICS, METHOD FOR PRODUCING THE SAME, AND METHOD FOR CONVERTING THE WASTE PLASTICS USING THE SAME

(71) Applicant: KOREA INSTITUTE OF SCIENCE AND TECHNOLOGY, Seoul (KR)

(72) Inventors: Chun-Jae YOO, Seoul (KR); Kwang Ho KIM, Seoul (KR); Chang Soo KIM, Seoul (KR); Kyeongsu KIM, Seoul (KR); Jae Wook CHOI, Seoul (KR); Dong Jin SUH, Seoul (KR); Jeong-Myeong HA, Seoul (KR); Young Hyun YOON, Seoul (KR); Hyun Joo LEE, Seoul (KR); Achmad Buhori, Seoul (KR)

(21) Appl. No.: 18/955,625

(22) Filed: Nov. 21, 2024

(30) Foreign Application Priority Data
Dec. 5, 2023 (KR) 10-2023-0174198

(51) Int. Cl. B01J 23/10; B01J 23/63; B01J 37/04; B01J 37/08; B01J 37/18

(52) U.S. Cl. CPC B01J 23/10; B01J 23/63; B01J 37/04; B01J 37/08; B01J 37/18

(57) ABSTRACT

The present disclosure discloses a catalyst for hydrogenolysis reaction of waste plastics, a method for producing the same, and a method for converting the waste plastics using the same. The catalyst comprises a ceria carrier; and a transition metal supported on the carrier. The catalyst has the effect of producing hydrocarbon compounds such as naphthas, fuels, and lubricants from waste plastics at a low temperature of 200 to 250° C.

### CROSS REFERENCE TO RELATED APPLICATION

The present application claims the priority of Korean Patent Application No. 10-2023-0174198, filed on Dec. 5, 2023, the entire content of which is incorporated herein for all purposes by this reference.

### BACKGROUND OF THE INVENTION

### Field of the Invention

The present disclosure discloses a catalyst for hydrogenolysis reaction of waste plastics, a method for producing the same, and a method for converting the waste plastics using the same.

### DESCRIPTION OF GOVERNMENT-SPONSORED RESEARCH

This research was conducted at the Korea Institute of Science and Technology (KIST) under the management of the Korea Institute of Science and Technology under the Ministry of Science and ICT. The research business name is the Korea Institute of Science and Technology's Research Operation Expense Support (Main business expense), and the research project name is the Development of Source Technology on Electro Super Cellulose Composite Material (Project Unique Identification Number: 1711196516, Project Identification Number: 2E32520).

Further, this research was conducted at the Korea Research Institute of Chemical Technology (KRICT) under the management of the National Research Foundation of Korea under the Ministry of Science and ICT. The research business name is the Development of Petroleum-Alternative Eco-Friendly Chemical Technology, and the research project name is the Development of Plastic Refinery Innovation Technology for producing BTX Basic Chemical Raw Material (Project Unique Identification Number: 1055001310, Project Identification Number: 2022M3J5A1051712).

### Description of the Related Art

According to the OECD Global Plastic Outlook Report, the amount of plastic currently discarded worldwide is 353 million tons (2019), and it is predicted that the amount would increase to 1.014 billion tons by 2060. However, most of the waste plastics is disposed of through landfill (50%) or incineration (19%), and the recycling rate is significantly low at 17%. Therefore, technology is required to solve the problem of environmental pollution through landfills and large-scale carbon dioxide emissions through incineration.

A method for recycling waste plastics is to pyrolyze the waste plastics and convert them into usable oil, which is called waste plastic pyrolysis oil. However, existing pyrolysis technology causes problems of generating a large amount of gas and coke due to decomposition at a high temperature (500 to 600° C.), which results in low yield and impossibility of continuous operation.

### SUMMARY OF THE INVENTION

In an aspect, the purpose of the present disclosure is to provide a catalyst for hydrogenolysis reaction of waste plastics.

In other aspect, the purpose of the present disclosure is to provide a method for producing the catalyst for hydrogenolysis reaction of waste plastics.

In another aspect, the purpose of the present disclosure is to provide a method for converting waste plastics using the catalyst for hydrogenolysis reaction of waste plastics.

In an aspect, the present disclosure provides a catalyst for hydrogenolysis reaction of waste plastics, comprising a ceria carrier; and a transition metal supported on the carrier.

In an exemplary embodiment, the ceria carrier may have a nanorod shape.

In an exemplary embodiment, the transition metal may be supported by strong electrostatic adsorption (SEA).

In an exemplary embodiment, the transition metal may include at least one selected from the group consisting of ruthenium (Ru), palladium (Pd), platinum (Pt), cobalt (Co), nickel (Ni), and copper (Cu).

In an exemplary embodiment, the transition metal may be supported in an amount of 0.1 to 10 mass % based on the total mass of the catalyst.

In an exemplary embodiment, the waste plastics may be polyolefin.

In an exemplary embodiment, the catalyst may be the one that can produce liquid and wax components usable as naphthas, fuels, and lubricants through the hydrogenolysis reaction of the waste plastics.

In an exemplary embodiment, the catalyst may be calcined at 200 to 500° C.

In another aspect, the present disclosure provides a method for producing the catalyst for hydrogenolysis reaction of waste plastics, comprising the steps of: (1) mixing a ceria precursor solution and a strong base and heat-treating the mixture without stirring; (2) filtering the heat-treated solution, washing the residue, and then drying and calcining the residue to prepare a ceria carrier of a nanorod shape; (3) dispersing the ceria carrier of the nanorod shape in deionized water and adding a transition metal precursor solution to the dispersion to prepare a mixture; (4) adjusting a pH of the mixture to 10 to 11 and then heat-treating the mixture; (5) filtering the heat-treated mixture, washing and drying the residue; and (6) calcining the dried product.

In an exemplary embodiment, the heat treatment in step (1) may be performed at 60 to 75° C.

In an exemplary embodiment, the heat treatment in step (4) may be performed at 140 to 160° C.

In another aspect, the present disclosure provides a method for converting waste plastics, that comprises performing hydrogenolysis reaction of waste plastics using the catalyst for hydrogenolysis reaction of waste plastics.

In an exemplary embodiment, the waste plastics and the catalyst may be mixed in a mass ratio of 1:1 to 30:1.

In an exemplary embodiment, the hydrogenolysis reaction may be performed under an initial hydrogen pressure condition of 20 to 65 bar at 200 to 300° C.

In an aspect, the technology disclosed in the present disclosure has the effect of providing a catalyst for hydrogenolysis reaction of waste plastics. The catalyst has the effect of producing hydrocarbon compounds such as naphthas, fuels, and lubricants from waste plastics at a low temperature of 200 to 250° C.

In another aspect, the technology disclosed in the present disclosure has the effect of providing a method for producing the catalyst for hydrogenolysis reaction of waste plastics.

In still another aspect, the technology disclosed in the present disclosure has the effect of providing a method for converting waste plastics using the catalyst for hydrogenolysis reaction of waste plastics. Through the hydrogenolysis of waste plastics, it is possible to produce naphthas, fuels, and lubricants.

### BRIEF DESCRIPTION OF THE DRAWINGS

FIG. 1 schematically shows a process for producing naphthas, fuels, lubricants, etc. from polyolefin-based waste plastics through a hydrogenolysis reaction.

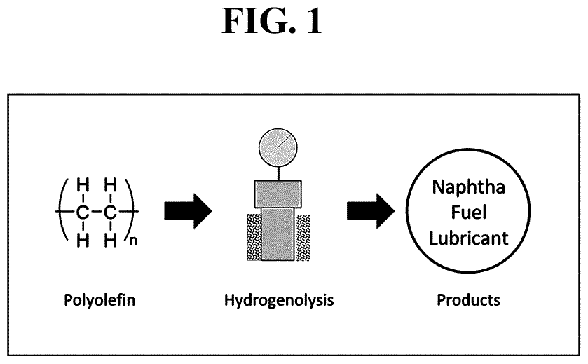

FIG. 2 shows results of a polyethylene hydrogenolysis reaction using a ruthenium-supported catalyst in one experimental example. (Top) Product yield, (Bottom) Carbon distribution

FIG. 3 shows a product yield and a methane selectivity of a polyethylene hydrogenolysis reaction according to a calcination temperature and a ruthenium-supported amount in one experimental example.

FIG. 4 shows a product yield and a methane selectivity of a polyethylene hydrogenolysis reaction according to a type of the carrier and a ruthenium-supporting method in one experimental example.

FIG. 5 shows a product yield and methane selectivity of a polyethylene hydrogenolysis reaction according to the initial hydrogen pressure in one experimental example.

FIG. 6 shows a carbon length distribution of a polyethylene hydrogenolysis reaction product according to a reaction temperature in one experimental example.

### DETAILED DESCRIPTION OF THE INVENTION

Hereinafter, the present disclosure will be described in detail.

In an aspect, the present disclosure provides a catalyst for hydrogenolysis reaction of waste plastics, comprising a ceria carrier; and a transition metal supported on the carrier.

In an exemplary embodiment, the ceria carrier may have a nanorod shape.

In an exemplary embodiment, the transition metal may be supported by strong electrostatic adsorption (SEA).

In an exemplary embodiment, the strong electrostatic adsorption may be performed by dispersing the carrier in deionized water, adding a transition metal precursor solution to the dispersion, adjusting a pH of the mixture to 10 to 11, and then heat-treating the mixture.

In an exemplary embodiment, the heat treatment may be performed at 140 to 160° C.

In an exemplary embodiment, the strong electrostatic adsorption may be performed by, after the heat treatment, filtering the mixture, adjusting a pH of the residue to 6.8 to 7.2, and then drying and calcining the residue.

In an exemplary embodiment, the drying may be performed at 100 to 120° C.

In an exemplary embodiment, the calcination may be performed at 200 to 500° C., 200 to 400° C., 200 to 300° C., 200 to 250° C., or 250 to 300° C.

In an exemplary embodiment, the transition metal may include at least one selected from the group consisting of ruthenium (Ru), palladium (Pd), platinum (Pt), cobalt (Co), nickel (Ni), and copper (Cu).

In an exemplary embodiment, the transition metal may be ruthenium (Ru).

In an exemplary embodiment, the transition metal may be supported in an amount of 0.1 to 10 mass % based on the total mass of the catalyst. In another exemplary embodiment, the transition metal may be supported in an amount of 0.1 mass % or more, 0.5 mass % or more, 1 mass % or more, 2 mass % or more, or 3 mass % or more, based on the total mass of the catalyst, and may be supported in an amount of 10 mass % or less, 9 mass % or less, 8 mass % or less, 7 mass % or less, 6 mass % or less, 5 mass % or less, 4 mass % or less, or 3 mass % or less, based on the total mass of the catalyst.

In an exemplary embodiment, the catalyst may be calcined at 200 to 500° C., 200 to 400° C., 200 to 300° C., 200 to 250° C., or 250 to 300° C.

In an exemplary embodiment, the waste plastics may be polyolefin.

In an exemplary embodiment, the polyolefin may include at least one selected from the group consisting of polyethylene, polypropylene, polystyrene, and polyvinyl chloride.

In an exemplary embodiment, the catalyst may produce liquid and wax components usable as naphthas, fuels, and lubricants through the hydrogenolysis reaction of the waste plastics.

In an exemplary embodiment, the liquid component may include a hydrocarbon compound having 5 to 20 carbon atoms, and the wax component may include a hydrocarbon compound having 21 to 41 carbon atoms.

In another exemplary embodiment, the liquid component may consist of a hydrocarbon compound having 5 to 20 carbon atoms, and the wax component may consist of a hydrocarbon compound having 21 to 41 carbon atoms.

The catalyst according to the present disclosure has the effect of reducing a ratio of gas components in the hydrogenolysis reaction of waste plastics and increasing an amount of liquid and wax components that can be used as naphthas, fuels, and lubricants.

In an exemplary embodiment, the catalyst may be the one that reduces methane selectivity in the hydrogenolysis reaction of waste plastics. For example, the catalyst may reduce the methane selectivity in the hydrogenolysis reaction of waste plastics to 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, or 3% or less.

In another aspect, the present disclosure provides a method for producing the catalyst for hydrogenolysis reaction of waste plastics, comprising the steps of: (1) mixing a ceria precursor solution and a strong base and heat-treating the mixture without stirring; (2) filtering the heat-treated solution, washing the residue, and then drying and calcining the residue to prepare a ceria carrier of a nanorod shape; (3) dispersing the ceria carrier of the nanorod shape in deionized water and adding a transition metal precursor solution to the dispersion to prepare a mixture; (4) adjusting a pH of the mixture to 10 to 11 and then heat-treating the mixture; (5) filtering the heat-treated mixture, washing and drying the residue; and (6) calcining the dried product.

In an exemplary embodiment, the strong base in step (1) may be selected from the group consisting of NaOH, KOH, LiOH, NH₄OH, and a combination thereof.

In an exemplary embodiment, the heat treatment in step (1) may be performed at 60 to 75° C.

In an exemplary embodiment, the drying in step (2) may be performed at 100 to 120° C.

In an exemplary embodiment, the calcination in step (2) may be performed at 350 to 450° C.

In an exemplary embodiment, the pH of the mixture in step (4) may be adjusted with Na₂CO₃.

In an exemplary embodiment, the heat treatment in step (4) may be performed at 140 to 160° C.

In an exemplary embodiment, the residue in step (5) may be washed until a pH thereof becomes 6.8 to 7.2 or 6.9 to 7.1.

In an exemplary embodiment, the drying in step (5) may be performed at 100 to 120° C.

In an exemplary embodiment, the calcination in step (6) may be performed under an air atmosphere at a temperature of 200 to 500° C., 200 to 400° C., 200 to 300° C., 200 to 250° C., or 250 to 300° C.

In an exemplary embodiment, the producing method may comprise a step of reducing under a hydrogen atmosphere at a temperature of 200 to 300° C. after the calcination in step (6).

In another aspect, the present disclosure provides a method for converting waste plastics, that comprises performing hydrogenolysis reaction of waste plastics using the catalyst for hydrogenolysis reaction of waste plastics.

The method for converting waste plastics according to the present disclosure has the effect of producing hydrocarbon compounds of various carbon lengths that can be used as naphthas, fuels, and lubricants from waste plastics through hydrogenolysis reaction at a low temperature of 200 to 300° C. or 200 to 250° C., unlike a general thermal decomposition reaction. The method has the effect of generating very little coke due to the use of hydrogen compared to the general thermal decomposition reaction and enabling continuous operation.

In an exemplary embodiment, the waste plastics and the catalyst may be mixed in a mass ratio of 1:1 to 30:1, a mass ratio of 10:1 to 30:1, a mass ratio of 15:1 to 25:1, or a mass ratio of 18:1 to 22:1.

In an exemplary embodiment, the hydrogenolysis reaction may be carried out under an initial hydrogen pressure condition of 20 to 65 bar. In another exemplary embodiment, the hydrogenolysis reaction may be carried out under the initial hydrogen pressure condition of 20 bar or more, 25 bar or more, 30 bar or more, 35 bar or more, or 40 bar or more, and 65 bar or less, 60 bar or less, 55 bar or less, 50 bar or less, 45 bar or less, 40 bar or less, 35 bar or less, 30 bar or less, or 25 bar or less.

In an exemplary embodiment, the hydrogenolysis reaction may be carried out at 200 to 300° C. In another exemplary embodiment, the hydrogenolysis reaction may be performed at a temperature of 200° C. or higher, 220° C. or higher, 240° C. or higher, 260° C. or higher, or 280° C. or higher, and 300° C. or lower, 280° C. or lower, 260° C. or lower, 240° C. or lower, or 220° C. or lower.

In an exemplary embodiment, the hydrogenolysis reaction may be performed for 5 to 20 hours. In another exemplary embodiment, the hydrogenolysis reaction may be performed for 5 hours or more, 6 hours or more, 7 hours or more, 8 hours or more, 9 hours or more, or 10 hours or more, and 20 hours or less, 19 hours or less, 18 hours or less, 17 hours or less, 16 hours or less, 15 hours or less, 14 hours or less, 13 hours or less, 12 hours or less, 11 hours or less, or 10 hours or less.

In an exemplary embodiment, the hydrogenolysis reaction may be preferably performed under an initial hydrogen pressure condition of 25 to 40 bar at 200 to 250° C. for 6 to 15 hours to increase the efficiency of hydrogenolysis reaction and reduce the methane selectivity.

Hereinafter, the present disclosure will be described through Examples in more detail. These Examples are intended only to illustrate the present disclosure, and it would be obvious to those skilled in the art that the scope of the present disclosure is not to be construed as being limited by these Examples.

### Example 1. Production of Catalyst

### (1) Synthesis of a Ruthenium-Supported Catalyst Using Wet Impregnation (WI)

Alumina (Al₂O₃), activated carbon (C), and zeolite (HB) used as a carrier were purchased from Sigma Aldrich®. Each carrier was dispersed in methanol as shown in Table 1 below, and ruthenium chloride hydrate (RuCl₃·3H₂O) of 3 mass % was added. After the mixture was stirred for 3 hours, a solvent was evaporated from the mixture at 45° C. using a rotary evaporator. The obtained powder was dried at 105° C. for 12 hours, and then calcined under an air atmosphere at 500° C. for 2 hours to synthesize ruthenium-supported catalysts, which were expressed as Ru/Al₂O₃, Ru/C, and Ru/HB.

TABLE 1

| | Methanol | Carrier | Ruthenium chloride hydrate |
|---|---|---|---|
| Ru/Al₂O₃ | 30 mL | Al₂O₃, 1 g | 0.076 g |
| Ru/C | 30 mL | C, 1 g | 0.076 g |
| Ru/HB | 30 mL | HB, 1 g | 0.076 g |

### (2) Synthesis of Ru/CeO₂ Catalyst Using Wet Impregnation (WI)

2.5 g of cerium nitrate hexahydrate (Ce(NO₃)₃·6H₂O) and 25 mL of NaOH (15 M) were dissolved in an autoclave Teflon container. After the autoclave chamber was sealed and heated in an oven at 70° C. for 10 hours without stirring, the solution was filtered, washed, and dried at 105° C. overnight. The dried product was calcined under an air atmosphere at 400° C. for 3 hours to synthesize ceria (CeO₂—NR) of a nanorod shape. Meanwhile, ceria (CeO₂—NC) of a nanocube shape was purchased from Sigma Aldrich®.

The prepared CeO₂—NC and CeO₂—NR carriers were dispersed in methanol, and then 1-3 mass % of ruthenium chloride hydrate (RuCl₃·3H₂O) was added. After the mixture was stirred for 3 hours, a solvent was evaporated from the mixture at 45° C. using a rotary evaporator. The obtained powder was dried at 105° C. for 12 hours, and then calcined under an air atmosphere at 250° C. or 500° C. for 2 hours to synthesize ruthenium-supported catalysts, which were expressed as Ru/CeO₂—NC—WI and Ru/CeO₂—NR—WI.

TABLE 2

| | Methanol | Carrier | Ruthenium chloride hydrate |
|---|---|---|---|
| 1% Ru/ | 30 mL | CeO₂—NC, | 1% Ruthenium chloride |
| CeO₂—NC—WI | | 1 g | hydrate, 0.025 g |
| 3% Ru/ | 30 mL | CeO₂—NC, | 3% Ruthenium chloride |
| CeO₂—NC—WI | | 1 g | hydrate, 0.076 g |
| 1% Ru/ | 30 mL | CeO₂—NR, | 1% Ruthenium chloride |
| CeO₂—NR—WI | | 1 g | hydrate, 0.025 g |
| 3% Ru/ | 30 mL | CeO₂—NR, | 3% Ruthenium chloride |
| CeO₂—NR—WI | | 1 g | hydrate, 0.076 g |

### (3) Synthesis of Ru/CeO₂ Catalyst Using Strong Electrostatic Adsorption (SEA)

The CeO₂—NC and CeO₂—NR carriers prepared in (2) above were dispersed in deionized water (DI water), and 3 mass % of ruthenium chloride hydrate (RuCl₃·3H₂O) was added. The mixture was stirred for 2 hours while maintaining a pH of the mixture to 11 using Na₂CO₃ (1 M), and then transferred to an autoclave Teflon container. The sealed autoclave was heated in an oven at 150° C. for 15 hours. The mixture was filtered, washed with a large amount of deionized water and ethanol until the pH became 7, and then dried at 105° C. for 12 hours. The dried product was calcined under an air atmosphere at 250° C. for 2 hours, and reduced under a 5% (v/v) H₂/Ar atmosphere at 250° C. for 4 hours. The obtained catalysts were expressed as Ru/CeO₂—NC-SEA and Ru/CeO₂—NR-SEA.

TABLE 3

| | | | Ruthenium |
|---|---|---|---|
| | Deionized | | chloride |
| | water | Carrier | hydrate |
| Ru/CeO₂—NC—SEA | 30 mL | CeO₂—NC, 1 g | 0.076 g |
| Ru/CeO₂—NR—SEA | 30 mL | CeO₂—NR, 1 g | 0.076 g |

### Experimental Example 1. Hydrogenolysis Reaction According to Type of Carrier

The hydrogenolysis reaction of polyethylene (PE) was performed in a batch reactor using the catalyst (Ru/Al₂O₃, Ru/C, Ru/HB, 3% Ru/CeO₂—NC—WI) produced by the wet impregnation of Example 1 and calcined at 500° C. The reaction conditions were as follows: PE/catalyst (W/W) 20:1, reaction temperature 250° C., reaction time 6 hours, initial hydrogen pressure 25 bar. The gas and liquid mixtures obtained after the reaction were analyzed using a gas chromatography-FID (GC/FID). The yield and selectivity of the product were calculated using the following equations:

Yield of product=(product mass/initial polyethylene mass)×100

Selectivity of product=(specific product mass/total product mass)×100.

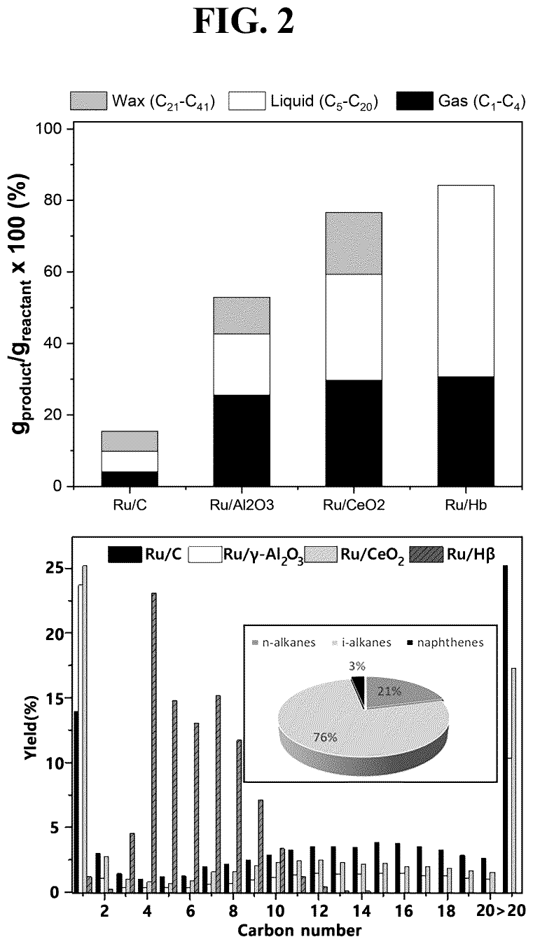

As a result of the hydrogenolysis reaction of polyethylene, it was confirmed that an amount of liquid and wax components that can be used as naphthas, fuels, and lubricants decreased in the order of Ru/Hβ>Ru/CeO₂>Ru/Al₂O₃>Ru/C. In case of the Ru/HB catalyst, the hydrogenolysis activity was the highest compared to the other catalysts, but the hydrocarbon compounds having relatively short carbon length (C1-C9) were produced, and most of them had branched structures. In case of the other catalyst groups (Ru/CeO₂, Ru/Al₂O₃, and Ru/C), the linear hydrocarbon compounds having various carbon lengths from C1 to C40 were produced, but high yield of methane were shown (see FIG. 2).

### Experimental Example 2. Hydrogenolysis Reaction According to Calcination Temperature and Ruthenium-Supported Amount

The hydrogenolysis reaction was performed according to the method of Experimental Example 1 using 3% Ru/CeO₂—NC—WI catalysts obtained by Example 1 and calcined at 250° C. and 500° C., respectively. The reaction conditions were as follows: PE/catalyst (W/W) 20:1, reaction temperature 250° C., reaction time 6 hours, initial hydrogen pressure 25 bar.

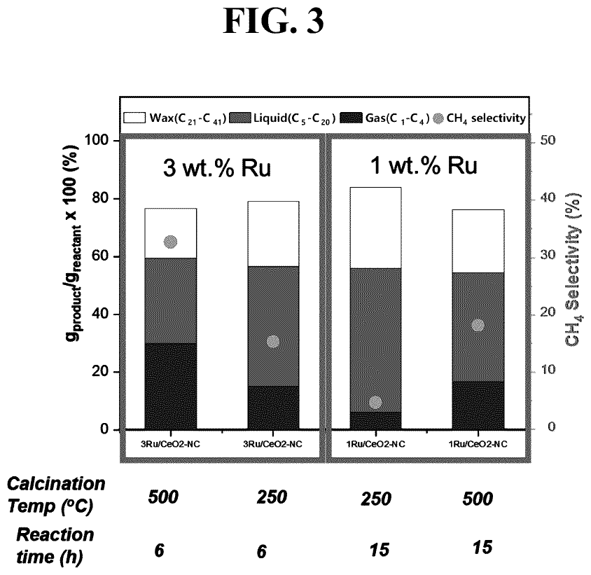

As a result, as shown in FIG. 3, it was confirmed that although the total amount of the products obtained by the hydrogenolysis reaction was similar to about 80%, the selectivity of methane gas was significantly reduced from about 35% to about 16% when the 3% Ru/CeO₂—NC—WI catalyst calcined at 250° C. was used.

Further, the hydrogenolysis reaction was performed according to the method of Experimental Example 1 using 1% Ru/CeO₂—NC—WI catalysts obtained by Example 1 and calcined at 250° C. and 500° C., respectively. The reaction conditions were as follows: PE/catalyst (W/W) 20:1, reaction temperature 250° C., reaction time 15 hours, initial hydrogen pressure 25 bar.

As a result, as shown in FIG. 3, it was confirmed that although the total amount of the products obtained by the hydrogenolysis reaction was similar to about 80%, the selectivity of methane gas was significantly reduced from about 20% to about 5% when the 1% Ru/CeO₂—NC—WI catalyst calcined at 250° C. was used.

### Experimental Example 3. Hydrogenolysis Reaction According to Type of Carrier and Ruthenium-Supporting Method

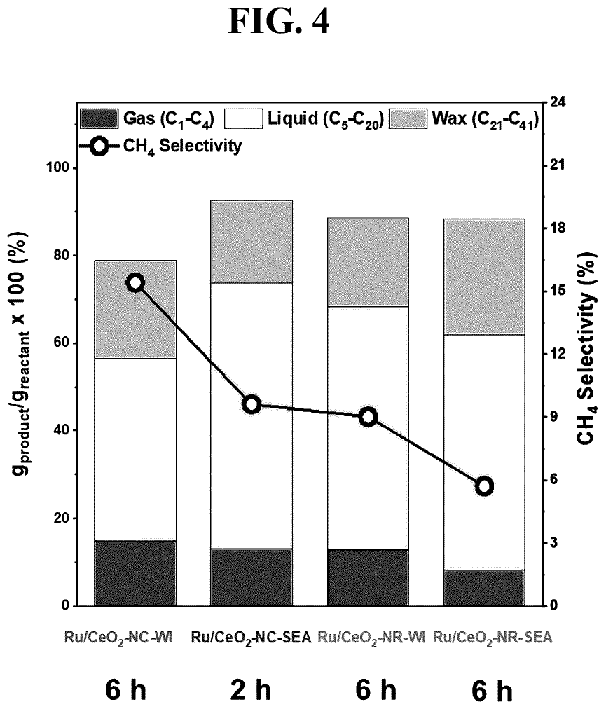

The hydrogenolysis reaction was performed according to the method of Experimental Example 1 using 3% Ru/CeO₂—NC—WI, 3% Ru/CeO₂—NR—WI, 3% Ru/CeO₂—NC-SEA, and 3% Ru/CeO₂—NR-SEA catalysts obtained by Example 1 and calcined at 250° C. The reaction conditions were as follows: PE/catalyst (W/W) 20:1, reaction temperature 250° C., reaction time 2 hours or 6 hours, and initial hydrogen pressure 25 bar. A difference in the activity depending on the carrier types (cubic or rod) of the Ru/CeO₂ catalyst and the ruthenium-supporting method (wet impregnation (WI) or strong electrostatic adsorption (SEA)) was shown in FIG. 4. The selectivity of methane was shown under conditions where the yield of the total product was 80% or more.

As a result, the reaction activity greatly changed depending on the type of CeO₂ used as the carrier. The Ru/CeO₂—NC—WI catalyst using ceria with a cubic structure showed the selectivity of methane of about 16%, whereas the Ru/CeO₂—NR—WI catalyst using ceria with a rod structure showed the selectivity of methane of about 9%. In case of the catalysts with different ruthenium-supporting method, the Ru/CeO₂—NC-SEA catalyst showed the selectivity of methane of about 9.5%, whereas the Ru/CeO₂—NR-SEA catalyst showed the selectivity of methane of about 6%.

Through this, it was found that the selectivity of methane was lower when ceria having a rod shape rather than a cubic shape was used as the carrier. In addition, it was confirmed that even when using ceria of the same shape, the catalyst which supports ruthenium using the strong electrostatic adsorption rather than a general impregnation could have a lower selectivity of methane.

Meanwhile, the Ru/CeO₂—NR-SEA catalyst reached a yield of 80% or more in 2 hours due to its excellent activity, which took 6 hours for the other catalysts. Therefore, it was confirmed that the catalyst in which ruthenium was supported on the ceria carrier having a cubic shape using the strong electrostatic adsorption provided excellent hydrogenolysis reaction activity.

### Experimental Example 4. Hydrogenolysis Reaction According to Initial Hydrogen Pressure

The hydrogenolysis reaction was performed under various initial hydrogen pressure conditions according to the method of Experimental Example 1, using the 3% Ru/CeO₂—NR-SEA catalyst obtained by Example 1. The reaction conditions were as follows. PE/catalyst (W/W) 20:1, reaction temperature 250° C., reaction time 6 hours, initial hydrogen pressure 5-65 bar.

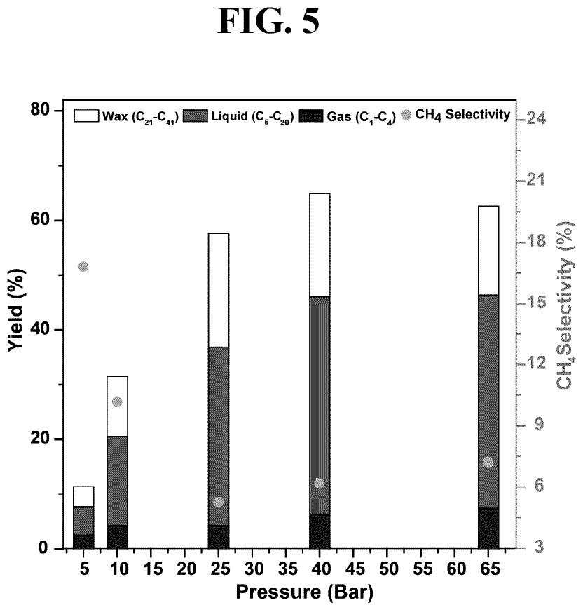

As a result, as shown in FIG. 5, it was found that if the reaction pressure was low, the yield of the reaction product was low whereas the selectivity of methane was very high, and as the reaction pressure increased, the yield of the reaction product increased while the selectivity of methane tended to decrease.

### Experimental Example 5. Hydrogenolysis Reaction According to Calcination Temperature and Ruthenium-Supported Amount

The hydrogenolysis reaction was performed under various reaction temperature conditions according to the method of Experimental Example 1, using the 3% Ru/CeO₂—NR-SEA catalyst obtained by Example 1. The reaction conditions were as follows: PE/catalyst (W/W) 20:1, reaction temperature 200-270° C., reaction time 6 hours, initial hydrogen pressure 25 bar.

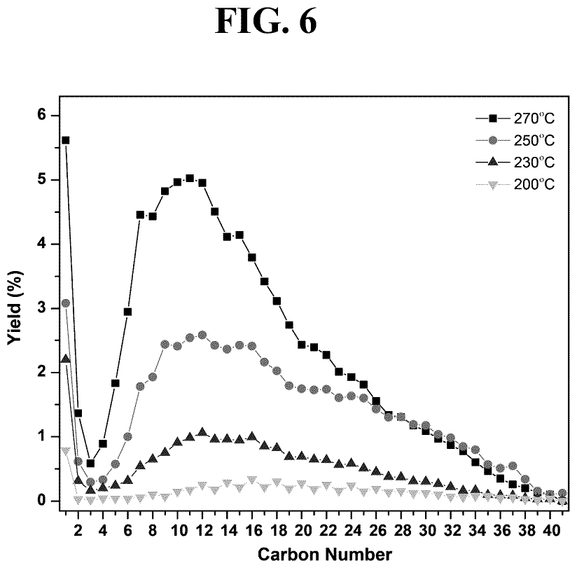

As a result, as shown in FIG. 6, it was shown that when the reaction temperature was 200° C., the amount of product was very small and the carbon length of the product was widely distributed from C to C30. It was confirmed that as the temperature increased, the amount of product increased and the yield of hydrocarbon compounds having a carbon length of C10 to C12 increased significantly.

As described above, although the specific descriptions of the present disclosure have been explained in detail, it would be apparent to those skilled in the art that such specific descriptions are merely preferred embodiments and do not limit the scope of the present disclosure. Accordingly, the substantial scope of the present disclosure should be defined by the appended claims and their equivalents.

What is claimed is:

1. A catalyst for hydrogenolysis reaction of waste plastics, comprising:
a ceria carrier; and
a transition metal supported on the carrier.

2. The catalyst for hydrogenolysis reaction of waste plastics according to claim 1,
wherein the ceria carrier has a nanorod shape.

3. The catalyst for hydrogenolysis reaction of waste plastics according to claim 1,
wherein the transition metal is supported by strong electrostatic adsorption (SEA).

4. The catalyst for hydrogenolysis reaction of waste plastics according to claim 1,
wherein the transition metal comprises at least one selected from the group consisting of ruthenium (Ru), palladium (Pd), platinum (Pt), cobalt (Co), nickel (Ni), and copper (Cu).

5. The catalyst for hydrogenolysis reaction of waste plastics according to claim 1,
wherein the transition metal is supported in an amount of 0.1 to 10 mass % based on the total mass of the catalyst.

6. The catalyst for hydrogenolysis reaction of waste plastics according to claim 1,
wherein the waste plastics are polyolefin.

7. The catalyst for hydrogenolysis reaction of waste plastics according to claim 1,
wherein the catalyst is the one that produces liquid and wax components usable as naphthas, fuels, and lubricants through the hydrogenolysis reaction of the waste plastics.

8. The catalyst for hydrogenolysis reaction of waste plastics according to claim 1,
wherein the catalyst is calcined at 200 to 500° C.
